(19) United States
(12) Patent Application Publication
(10) Pub. No.: US 2006/0101111 A1
(43) Pub. Date: May 11, 2006

(54) Method and apparatus transferring arbitrary binary data over a fieldbus network

(75) Inventors: Kai T. Bouse, Tellico Plains, TN (US); Michael D. Medley, Knoxville, TN (US); Christopher G. Hilemon, Knoxville, TN (US)

Correspondence Address: LUEDEKA, NEELY & GRAHAM, P.C., P O BOX 1871, KNOXVILLE, TN, 37901, US

(73) Assignee: CSI Technology, Inc.

(21) Appl. No.: 11/244,115

(22) Filed: Oct. 5, 2005

Related U.S. Application Data
(60) Provisional application No. 60/616,192, filed on Oct. 5, 2004.

(51) Int. Cl. G06F 15/16

(52) U.S. Cl. 709/200

(57) ABSTRACT

A data transfer system utilizes one or more standard parameters in a fieldbus messaging system as a mechanism to move arbitrarily large blocks of arbitrary binary data into and out of a field device. The preferred embodiment of the invention moves delineated streams of octets across a virtual connection to and from the device by layering and tunneling, utilizing the underlying fieldbus network as a transport mechanism. These octet sequences are referred to as VStreams™. One or more devices on the fieldbus network may have one or more VStreams™ active simultaneously, in either direction. Preferably, a standard multi-byte parameter supported by the fieldbus is defined for use as a window, preferably as large as the underlying fieldbus will allow. Writes to this parameter are interpreted as sequential transfers of data in to the field device. Reads from this parameter are interpreted as sequential transfers of data out of the field device.

This application claims priority to U.S. provisional patent application 60/616,192 filed Oct. 5, 2004.

### FIELD OF THE INVENTION

This invention relates to data transfer devices and methods. More particularly the invention relates to an apparatus and method for transferring data over a fieldbus network between a fieldbus device and a host application.

### BACKGROUND

The FOUNDATION™ fieldbus (Ff) is an all-digital, two-way communications system that interconnects measurement and control equipment such as sensors, actuators and controllers. These measurement and control devices are referred to herein as fieldbus devices. At the base level in the hierarchy of plant networks, the fieldbus serves as a Local Area Network (LAN) for instruments used in process control and manufacturing automation applications. The fieldbus has a built-in capability to distribute control applications across the network.

Unlike proprietary network protocols, FOUNDATION™ fieldbus is neither owned by any individual company, or regulated by a single nation or standards body. The technology is controlled by the Fieldbus FOUNDATION, a not-for-profit organization consisting of more than 100 of the world's leading controls and instrumentation suppliers and end users.

Typical techniques for transferring data into and out of a fieldbus device, such as a machine monitoring device, are to define singular named parameter values which may be read and/or written using bus-specific commands. The sizes of these transferred data blocks are typically small, usually on the order of tens of bytes or less. It is desirable to implement an improved transfer system for efficiently moving larger blocks of data into and out of a fieldbus device.

### SUMMARY

The above and other needs are met by a data transfer system that utilizes one or more standard simple parameters as a mechanism to move arbitrarily large blocks of arbitrary binary data into and out of a fieldbus device. The preferred embodiment of the invention moves delineated streams of bytes across a virtual connection to the device by layering and tunneling, utilizing the underlying fieldbus network as a generic reliable transport. These streams are referred to herein as VStreams™. One or more devices may have one or more VStreams™ moving data in either direction simultaneously.

According to a preferred embodiment, a standard multi-byte parameter that is natively supported by the fieldbus is defined for use as a window. This parameter is preferably as large as the underlying fieldbus will allow. Writes to this parameter are interpreted as sequential transfers of data into the device. Reads from this parameter are interpreted as sequential transfers of data out of the device.

Each VStream™ transfer is initiated by writing through the parameter a special block which contains information identifying it as a stream header. Among other things, the header includes a unique stream identifier for associating segments with the stream, a count of the overall stream length, and a cyclic redundancy check value (CRC) for validation. Each VStream™ transfer is continued by writing through the parameter a block which contains information identifying it as the next fragment of an active stream. In addition to the next segment of the stream, each block includes among other things the stream identifier, the current segment window identifier, and a CRC for validation.

The preferred embodiment of the invention provides a mechanism for fragmenting arbitrary blocks of data, transporting those fragments reliably over the underlying fieldbus, and reassembling the fragments in the device or at the host. Using this mechanism, the invention provides for: (1) transferring arbitrarily sized blocks of data that have been too large to manage with standard fieldbus parameters; (2) transferring firmware modules for updating device capabilities in the field or archiving at the host; (3) transferring arbitrarily sized blocks of proprietary data for historical purposes and detailed analysis; and (4) implementing a standard protocol such as the PPP variant of TCP/IP that requires a reliable underlying transport mechanism while imposing a minimum amount of overhead for bookkeeping.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 depicts a fieldbus network according to a preferred embodiment of the invention;

FIG. 2 depicts a schematic overview of a Pending Output Queue according to a preferred embodiment of the invention;

FIG. 3 depicts a schematic overview of an Active Output List according to a preferred embodiment of the invention;

FIG. 4 depicts a HEADER Fieldbus Messaging Specification (FMS) Read process for initiating a stream transfer according to a preferred embodiment of the invention;

FIG. 5 depicts a SEGMENT FMS Read process for managing an Active Output List according to a preferred embodiment of the invention;

FIG. 6 depicts a lowest level of a network stack for communicating with a fieldbus output board from a fieldbus device according to a preferred embodiment of the invention;

FIG. 7 depicts a logical messaging infrastructure layered on top of a Rosemount FOUNDATION™ Fieldbus Interface (RFFI) to manage VStreams™ according to a preferred embodiment of the invention;

FIG. 8 depicts a data compression and encoding technique for time waveform data according to a preferred embodiment of the invention; and

FIG. 9 depicts a data compression and encoding technique for spectral data according to a preferred embodiment of the invention.

### DETAILED DESCRIPTION

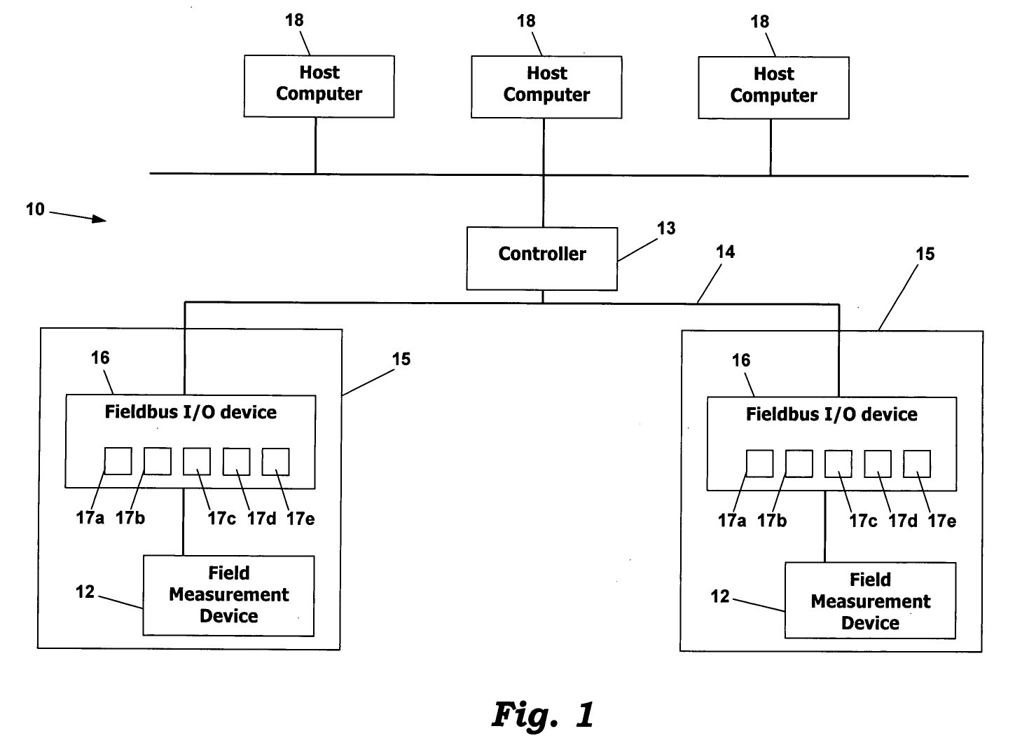

As shown in FIG. 1, the invention provides a system 10 for moving arbitrary blocks of data into and out of a fieldbus device 15, such as a machine health transmitter, over a fieldbus network 14. The fieldbus device 15 comprises a field measurement device 12 and a fieldbus input/output (I/O) device 16, such as a Rosemount FOUNDATION™ fieldbus output board. The system 10, referred to herein as the VStream™ messaging system, includes a handshaking mechanism between the field measurement device 12 and the fieldbus input/output (I/O) device 16. The system also includes a command structure for data requests and responses between the fieldbus device 15 and support applications running on a host computer 18. One example of a fieldbus device 15 compatible with the invention is the Model 9210 Machinery Health Transmitter manufactured by Computational Systems, Inc.

Generally, the primary mechanism for a fieldbus device 15 to publish data is through transducer blocks of the fieldbus output board 16. The transducer blocks are represented in FIG. 1 by blocks 17a-17e. In the case of a machine condition monitor device, specific measurements that are indicative of the health of the monitored machinery are exposed as sensor data, such as temperature or vibration data. Such data has traditionally been captured and saved in a persistent storage location for historical analysis when problems occur. Such data may also be useful for dynamic validation of automatically produced analysis results. Examples include information from internal trend buffers or intermediate analysis results, and more traditional data such as vibration time series (waveforms) and vibration frequency blocks (spectra).

While it is possible for the host computer 18 to communicate directly on the fieldbus network 14 in some embodiments of the invention, preferred embodiments include a controller 13, such as a DeltaV controller or a Rosemount 3420 communications concentrator. In these embodiments, the controller 13 provides communication with the host computer 18 using Ethernet protocol and with the multiple fieldbus devices 15 using H1 fieldbus protocol.

One of the primary considerations in transferring significant amounts of machine health data is the limitation imposed by using a FOUNDATION™ fieldbus network or equivalent network as a transport. In the past, transferring such information has been somewhat problematic because the maximum transfer unit (MTU) of the fieldbus protocol is only about 100 octets (8-bit bytes) and the maximum transfer rate is about 30 Kbaud. The size of a simple 400-line frequency spectrum is typically about 1600 bytes in its raw form. Some form of data compression is generally required to transfer significant quantities of such information.

Furthermore, the FOUNDATION™ fieldbus network is intended primarily for managing a live process where all messages are strictly limited in size and frequency to ensure accurate and timely control. The FOUNDATION™ fieldbus network bandwidth is generally allocated using a time-division multiplexing method of “slots” and a “token ring.” Accordingly, time available for transferring arbitrary “unscheduled” data within the overall macro-cycle is limited.

In any event, there is a need for a mechanism for moving arbitrary size blocks of data between the fieldbus device 15 and a host application on the host computer 18. The present invention provides a mechanism for accessing such data remotely across the fieldbus network 14 and message formats required for the data transfer. In order to maximize the use of the limited bandwidth on the FOUNDATION™ fieldbus network, the preferred embodiment of the invention exchanges the high-resolution simplicity of transferring all the machine data, which would require hours of transfer time, for the lower-resolution but more responsive technique of transferring compressed snapshots of the data. This allows for interaction with the FOUNDATION™ fieldbus device in “real” time. The invention also addresses the timing constraints of the fieldbus output board 16, which generally cannot buffer large blocks of data (e.g., to perform fragmentation and reassembly). Thus, the invention provides a data transfer protocol for managing arbitrary size data block transfers from a field device 15 while satisfying the fairly tight timing constraints for the network stack of the fieldbus output board 16.

The FOUNDATION™ fieldbus does not provide a mechanism for a remote device to push unsolicited data over the bus. Further, within the initial operating environment of a Process Automation System, such as the DeltaV™ system developed by Emerson Process Management, there are significant limitations on the subset of standard services that the FOUNDATION™ fieldbus can provide. Accordingly, polling of the field device 15 has generally been the only mechanism available for discovering data waiting for extraction in the field device 15.

A preferred embodiment of the present invention addresses this problem by having the host application: (1) keep track of its data requests and use polling to extract the response; (2) use whatever mechanisms are available within the host system to detect when exceptional conditions have occurred in the monitored machine and data are likely to be waiting, and use polling to verify the presence of data and extract it if necessary; and (3) command periodic collection of data at a data collection interval that is based on timers under the management of the host application, rather than having the device 15 manage the report timing.

In the preferred embodiment of the invention, the fieldbus device 15 exposes its capability through the five transducer blocks 17a-17e within the fieldbus output board 16. These blocks roughly correspond to conceptual domains within the host application and can be thought of as “objects.” Each transducer block 17a-17e in the fieldbus output board 16 represents an information context, such as a group of related values. Within the fieldbus device 15 there are analogs of these blocks which represent the information in a manner suited to the analytical purposes of the device 15. The outer blocks contain configuration parameters that are typically scalar values managed by change messages across the network.

The link 14 is preferably a serial link. This link 14 is treated as a point-to-point “network” with a stack modeled roughly on the IEEE1451.1 model. Parameters are preferably addressed by unique identification numbers. Changes to “static” parameters come across the link 14 as write commands and are handled by a callback mechanism that routes the operation based on the identification numbers. Synchronous reads are handled similarly. Live sensor readings, such as analysis results, are preferably published across the link 14 by asynchronous messages to the fieldbus output board 16.

In the preferred embodiment of the invention, each arbitrarily sized data block is exported from the fieldbus device 15 to a host application in the host computer 18 by utilizing parameters to “window” the data block into a sequence of packets that are suitable for transfer across the FOUNDATION™ fieldbus. Preferably, a source of data in the fieldbus device 15, e.g., an analysis module, determines that certain information is important to be saved for decision support. This source of data performs a single “send” operation, similar to TCP/IP, which handles packetization of the byte stream automatically. The data are buffered in the device 15 pending a polling operation from the host 18 to discover the presence of the data.

The invention also provides for downloading information to the fieldbus device 15 from the host computer 18. For example, core operational firmware in the device 15 may need to be upgraded in the field, or the rules for analysis may need to be upgraded as techniques for detecting a particular fault are improved. In the past, the fieldbus mechanisms for downloading firmware have been problematic as they are primarily intended for updating control firmware in the fieldbus output board 16. In prior fieldbus networks, management of the caching between the fieldbus output board 16 and the field device 12 has been complex and potentially fragile. To address these problems, the preferred embodiment of the invention extends the extraction protocol to include downloads from a host computer 18 to the fieldbus device 15. The operation of the data transfer process described herein depends at least in part on the synchronous read and write capability of transducer block parameters between the fieldbus output board 16 and the field device 12.

In the preferred embodiment of the present invention, the transducer blocks 17a-17e transfer data blocks by means of a VSTREAM “object” which represents a communication link for transferring block data. The VSTREAM object provides a logical grouping of parameters that correspond to the concept of a “stream” in a transducer block 17a-17e. These parameters, which are available via the Fieldbus Messaging Specification (FMS), are UPLOAD_NOTIFY, COMMAND, TRANSFER and SLIDING_WINDOW. In the actual transducer blocks, the COMMAND parameter is shadowed by the XA_TOKEN parameter, the TRANSFER parameter is shadowed by the XA_HEADER parameter, and the SLIDING_WINDOW parameter is shadowed by the XA_SEGMENT parameter. In a preferred embodiment of the invention, the 229-byte VSTREAM object may be interpreted according to Table I. Descriptions of the individual parameters appear in Table II.

TABLE I

| Parameter Name | Class (D/S/N) | Use (I/O/C) | Access | Data Type (Index) | Size (bytes) | Default Value |
|---|---|---|---|---|---|---|
| UPLOAD_NOTIFY | SD | C | R | BOOL (1) | 1 | F |
| COMMAND | SD | C | W | TOKEN | 8 | |
| (XA_TOKEN) | | | | | | |
| TRANSFER | SD | C | RW | HEADER | 110 | |
| (XA_HEADER) | | | | | | |
| SLIDING_WINDOW | SD | C | RW | SEGMENT | 110 | |
| (XA_SEGMENT) | | | | | | |

TABLE II

| Parameter | Description |
|---|---|
| UPLOAD_NOTIFY | This Boolean flag is set True when the fieldbus device 15 has data ready to be extracted. It |
| | will be set under two specific circumstances: (1) a host upload request has been recognized, |
| | or (2) unsolicited data has been queued for retrieval. A read of this field will cause the value |
| | to automatically go False until the next time data becomes available. |
| COMMAND | This field is written from a host application to request an uplink of specific data. When this |
| | field is written (as XA_TOKEN), and the fieldbus device 15 has recognized the request, the |
| | UPLOAD_NOTIFY flag will be set to indicate the presence of data. |
| TRANSFER | This field contains the transmission header for the next block transfer to be initiated. Multiple |
| | transfers may be active simultaneously. Whenever this parameter is read (as XA_HEADER), |
| | the header for the next available output stream will be returned. If no transfers are pending, |
| | the contents will be automatically cleared to all zeroes. When written by a host application |
| | (as XA_HEADER) this record describes the header for a download operation to the fieldbus |
| | device 15, typically of new rule sets to upgrade the analysis capability. |
| SLIDING_WINDOW | This field contains the next data segment for a specific block transfer. Multiple block |
| | transfers may be active simultaneously. Whenever this parameter is read (as |
| | XA_SEGMENT) the next segment from the list of active output streams will be returned. If |
| | there are no active streams, the contents will be automatically cleared to all zeroes. When |
| | written by a host application (as XA_SEGMENT) this record represents the next sequential |
| | segment of an active download transaction to the fieldbus device 15. |

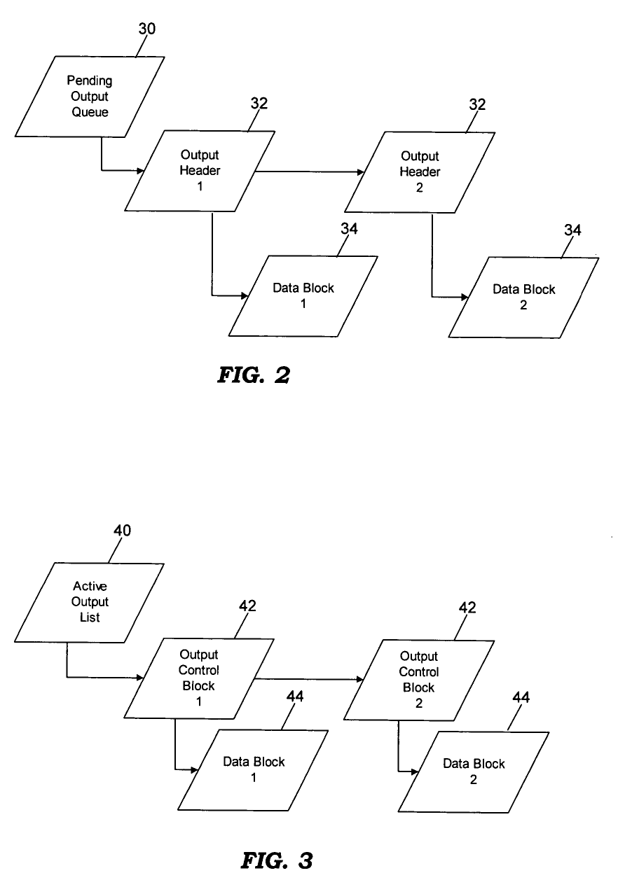

Within the fieldbus device 15 there are preferably queues of transmission request headers associated with the transducer blocks 17a-17e. FIG. 2 provides a schematic overview of a pending output queue 30 of the fieldbus device 15, and FIG. 3 depicts a schematic overview of an active output list.

In the preferred embodiment, a HEADER 32 describes a virtual circuit for transmission of a sequence of octets (a VStream™). As listed in Tables VI and VII, the HEADER 32 contains the ACTION token describing the unsolicited or requested data contained in the corresponding VStream™. The HEADER also contains the TOTAL_LENGTH of the buffer and the TIMESTAMP indicating the time of the event that triggered the transmission, which is the time of receipt for a request.

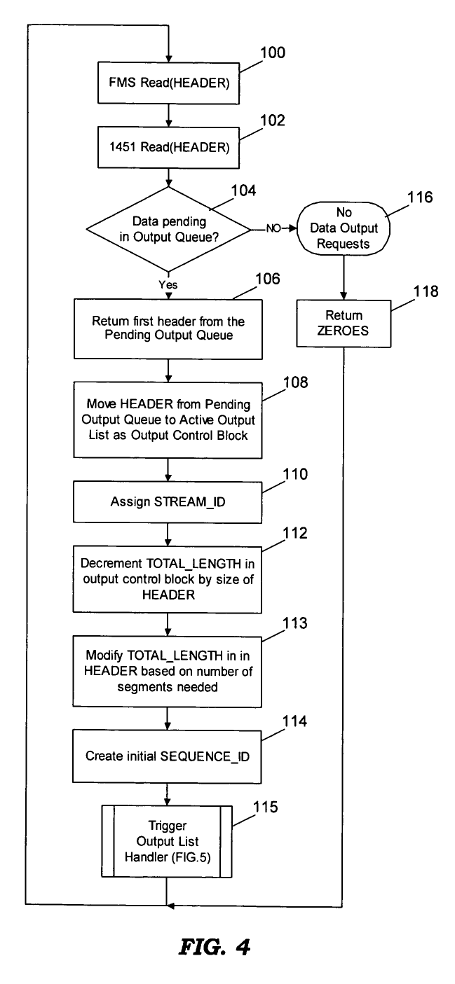

FIG. 4 depicts the FMS Read of XA_HEADER that initiates a stream transfer. As shown in FIG. 4, an FMS Read operation directed at the XA_HEADER parameter of a block (step 100) begins the process of transferring the data. If data is pending in the output queue 30 (step 104), the first HEADER 32 in the queue 30 is returned (step 106.) A read of the XA_HEADER parameter when no transmissions are pending (step 116) returns a block of all zeroes (step 118).

For the case of pending data, the data stream represented by the HEADER 32 is moved from the pending queue 30 to an active output list 40 (FIG. 3) for the block (step 108) and the stream is assigned a STREAM_ID (step 110). Theoretically, there can be 126 active streams per transducer block, where STREAM_ID values of zero and 127 are reserved; the MSB (0×80) is used as a RELIABLE_STREAM indicator. The TOTAL_LENGTH value in the output control block 42 is decremented by the size of the header (step 112). The TOTAL_LENGTH in the published HEADER is modified by calculating the number of segments of data that will be required to transfer the complete stream, and adding the overhead per segment, which includes the size of the header (step 113). Additionally, in the preferred embodiment the OVERALL_CRC is created by performing a cyclic redundancy check (CRC16) over the entire block of data, and the HEADER_CRC is created by calculating the CRC16 over the HEADER block, HEADER (step 114) according to the standards set by the Comité Consultatif International Téléphonique et Télégraphique (CCITT).

An ACTION token of zero (0) in a HEADER (see tables VI and VII) is considered a null operation and is discarded by the host application. This use of multiple parameters is preferred based on ease of use. However, the same results could be achieved by using a single block parameter and including a flag in the HEADER indicating whether the encapsulated data represents a new stream or a continuation of a stream.

Another way for a transmission HEADER to be placed into the pending output queue 30 is by a request from the host computer 18. In this process, XA_TOKEN is written to the COMMAND parameter of a transducer block 17a-17e which is forwarded to the field device 12 over the intra-device interface. If XA_TOKEN is valid, the field device 12 returns a “success” code and the request is queued to an input message handler, where it ultimately causes a response output header to be queued in the output queue 30. In the preferred embodiment, the COMMAND field returns zero if it is read from the transducer block 17a-17e.

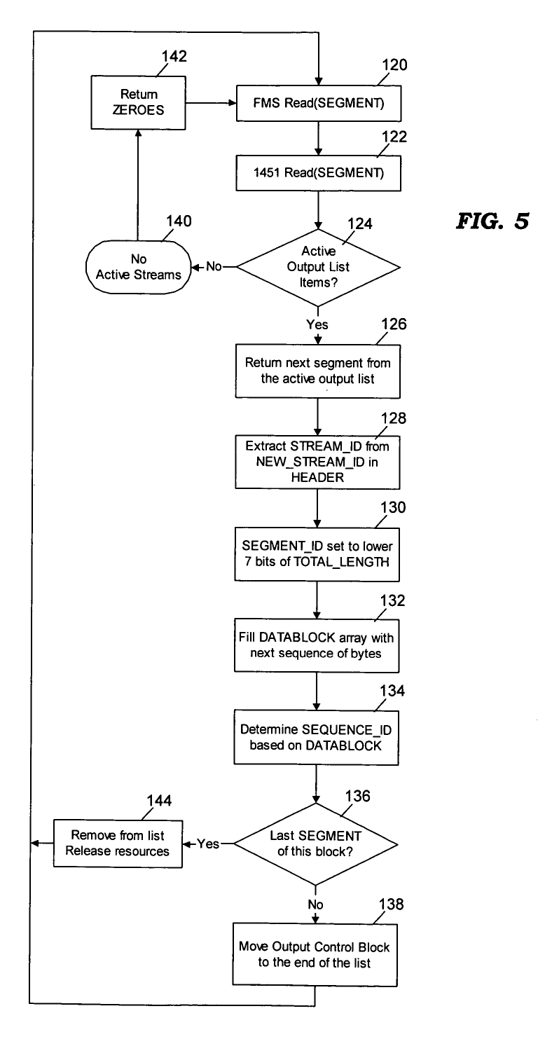

As shown in FIG. 5, the data transfer process is continued by a sequence of FMS Read operations directed at the XA_SEGMENT parameter of the output control block 42 (step 120). As the segments are read via the SEGMENT parameter, the segment wrapper is filled in from the output control block 42 as follows:
(1) The SEQUENCE_ID is set from what was NEW_STREAM_ID in the HEADER combined with the ordering position of this segment in the overall transmission;
(2) The DATABLOCK array is filled with the next sequence of bytes for this transmission, up to the maximum usable payload per segment (step 132); and
(3) The SEGMENT_CRC is the result of a CCITT CRC16 calculation over the SEQUENCE_ID and the current segment DATABLOCK (step 134).

At the host computer 18, this same process is performed in parallel as the data segments are received. If the SEQUENCE_ID disagrees, this indicates that the stream has been corrupted and should be discarded. Under these circumstances, the host 18 writes a token to the COMMAND parameter of the appropriate block with the MANAGE_STREAM primary value, ABORT_TRANSACTION secondary value, and the STREAM_ID as the primary parameter. If blocks are buffered piecewise and released as the transmission proceeds, the remainder of the VStream™ is flushed from the output list 40 and the contents of this particular block transfer are lost. However, if memory allows blocks to be held until the completion of the transfer, the transfer could potentially be restarted.

Preferably, all active streams in a transducer block 17a-17e are round-robin multiplexed through the single SEGMENT parameter of the associated block. For example, each FMS Read of the SEGMENT parameter (step 120) returns the next data segment of the stream at the head of the list (step 126), and moves that output control block 42 to the end of the list 40 (step 138). Thus, if there are N number of active data streams, a segment from any given stream will show up every Nth read operation. As streams complete (N decreases), the “interleave” rate of the remaining streams increases. If there is only a single active stream, it appears to a host application as if no interleaving were occurring, and every read (step 120) returns the next segment (step 126) of the single data stream.

A host application on the host computer 18 may initiate a download operation by simply writing to the HEADER parameter of the appropriate block, and all the rules described herein regarding the set up of the internal fields apply. The host application is responsible for ensuring that the active STREAM_ID values are unique within a particular block context. There is no requirement that the STREAM_ID values be contiguous or sequential, although the STREAM_ID values coming from the fieldbus device 15 satisfy both of these constraints.

Actual transfer of the data from the host 18 is accomplished by writing segments of the data through the SEGMENT parameter in the associated block. In the preferred embodiment, all the same rules apply regarding management of the SEGMENT_ID and SEQUENCE_ID parameters. As before, the use of multiple parameters to effect the transfer is merely a convenience.

The preferred embodiment of the invention provides for host management of multiple active data streams. Preferably, there are no requirements regarding how the segments of these streams should be multiplexed. Thus, the fieldbus device 15 preferably makes no assumptions about the interleave mechanism and simply appends segments to the appropriate data stream as the segments arrive according to the SEQUENCE_ID value.

Since the fieldbus device 15 generally cannot “source” a message to the host 18, the invention provides a means for the fieldbus device 15 to indicate a “failed” transfer. This occurs in a manner similar to the host aborting an upload that has been detected to be “bad.” Preferably, it does not require a completion of the download to the “bit bucket,” but allows the fieldbus device 15 to “early abort” the transfer. Preferably, the transfer process avoids two round-trip fieldbus operations per download segment while still allowing the early abort. In practice this is managed by exchanging a bitmap of which segments have been received and which ones need to be resent.

The fact that a particular stream is “reliable” is marked by the sign bit (MSB) of the STREAM_ID. This leaves open the question of how to specify which messages should use the technique. For response messages, the indication is setting the sign bit (MSB) of the CMD_CODE portion of the requesting TOKEN. If the device receives a command with this reliable response flag bit set, either in the header of a download stream transfer or independently through the COMMAND parameter, the response to that command is sent using the reliable transfer mechanism; i.e., the reliable stream flag will be set in the STREAM_ID. The echo of the command token in the response also has the reliable response flag bit set, just as in the request.

When the device produces unsolicited data, particularly event data which cannot be readily reproduced, it submits the data for transmission with a zero (0) transaction identifier to indicate that it is not a response to any command. It may also set the reliable stream flag in the STREAM_ID to indicate that the host agent should use the reliable upload handshake to guarantee success.

Reliable Downloads

The host agent prepares a stream transfer and sets the reliable stream flag bit (MSB) in the NEW_STREAM_ID field of the HEADER. This HEADER is written to the device as usual. The NEW_STREAM_ID, with the reliable stream flag bit set, is copied to the STREAM_ID field in each subsequent segment. The SEQUENCE_ID.SEGMENT_ID is set to the position of this segment in the stream; the first segment should get a SEGMENT_ID of one (1).

As the device receives each segment, the segment is placed in its proper location in the stream. When the device believes it has received the “last” segment (based on TOTAL_LENGTH from the HEADER), it will keep the stream in the active queue pending a ReleaseStream message with its stream identifier.

At any time during the transfer the host agent may send an AcknowledgeRequest message to the device. The device responds according to its current belief about the integrity and progress of the stream. The host agent resends any segments necessary to “fill in” holes identified by the response, or it abandons the transfer as a lost cause and sends an AbortAndFlush message to release the stream resources. The AcknowledgeRequest and resending cycle may be repeated an arbitrary number of times as needed.

Once the host agent believes the transfer to be complete it sends a ReleaseStream(D) message with the appropriate stream identifier, and the device transfers the completed message to the action queue where it will be processed at the next synchronization point.

Reliable Uploads

The host agent reads a new HEADER from the device and discovers the reliable stream bit (MSB) to be set in the NEW_STREAM_ID field. It makes whatever provisions are necessary to track the subsequent segments as they are received. The host agent issues a sequence of reads from the SEGMENT parameter of the device. Each segment is placed in its proper position in the stream. When the device believes it has sent the “last” segment (based on TOTAL_LENGTH from the HEADER) it keeps the stream in the active queue pending a ReleaseStream message with its stream identifier.

At any time during the transfer the host agent may send a RetransmitRequest message to the device. The device takes steps to ensure that further reads of the SEGMENT parameter eventually includes the specified segments. The host agent continues to request retransmission of “missing” segments until it believes the transfer has been successful or it decides to abandon the transfer as a lost cause and sends an AbortAndFlush message to release the stream resources. The RetransmitRequest and repeated segment transmission cycle may be repeated an arbitrary number of times as needed.

Once the host agent believes the transfer to be complete it sends a ReleaseStream(U) message with the appropriate stream identifier and the device releases the stream resources. Either an AbortAndFlush or a ReleaseStream(U) message may be used to release the active stream resources.

Record Object: TOKEN

The TOKEN data object represents a communication token for specifying upload or download requests, and for identifying any unsolicited data published by the fieldbus device 15 for historical or analysis purposes. The TOKEN object provides a mechanism to support a full command and response protocol between the fieldbus device 15 and the host computer 18. This object is the “memory template overlay” for the XA_TOKEN parameter in the transducer blocks 17a-17e. In the preferred embodiment, the 8-byte array corresponding to the TOKEN object returned from the device 15 is interpreted according to Table III. Descriptions of the individual fields in the TOKEN object appear in Table IV. Table V provides an example of the protocol using the requirements of stream management as its basis.

TABLE III

| | | | | | Data | | | | |
|---|---|---|---|---|---|---|---|---|---|
| | Class | Use | | | Type | Size | | Range | Default |
| Parameter Name | (D/S/N) | (I/O/C) | Access | Mode | (Index) | (bytes) | Range | Check | Value |
| CMD_CODE | SD | C | RW | Any | U8 (5) | 1 | [1, 126] | Y | 0 |
| CMD_SEC_CODE | SD | C | RW | Any | U8 (5) | 1 | [1, 254] | Y | 0 |
| CMD_PARAM | SD | C | RW | Any | U16 (6) | 2 | | | 0 |
| CMD_SEC_PARAM | SD | C | RW | Any | U16 (6) | 2 | | | 0 |
| CMD_TRAN_ID | SD | C | RW | Any | U16 (6) | 2 | [1, 65535] | | 0 |

TABLE IV

| Parameter Name | Description |
|---|---|
| CMD_CODE | This field is the primary command code for uplink requests and unsolicited data |
| | identification. It basically defines a processing facility or related group of commands. It is |
| | defined on the closed interval [1,126]. The MSB (reliable response flag) is used to indicate |
| | whether the response is to be handled using the reliable transport handshaking mechanism. |
| | The specific values zero (0) and 127 are reserved. |
| CMD_SEC_CODE | This field is the secondary command code for uplink requests and unsolicited data |
| | identification. It is defined on the closed interval [1,254]; zero and 255 are reserved values. |
| CMD_PARAM | This field is available as a primary parameter to modify the operation specified in |
| | CMD_CODE:CMD_SEC_CODE. Valid values depend on the specific command pair given. |
| CMD_SEC_PARAM | This field is available as a secondary parameter to the operation already identified by |
| | CMD_CODE:CMD_SEC_CODE:CMD_PARAM. Valid values depend on the specific |
| | command pair and primary parameter given. |
| CMD_TRAN_ID | This field is used by the host software to track requests and match up the responses. It is |
| | defined on the closed interval [1,65535]; zero is reserved. |

TABLE V

| | |
|---|---|
| Manage | CMD_CODE==[FE] |
| Streams | |
| DeferResponse | CMD_SUB_CODE == [01] |
| | PARAM == <DEFERRED CMD_CODE> |
| | SEC_PARAM == <DEFERRED CMD_SUB_CODE> |
| | Response |
| | { |
| | real32 delay |
| | } |

NOTE: This message is sent to the host 18 whenever a command is
received which can not be processed immediately. This may be because
the processing time will take too long and/or because it requires
synchronization with the analytical processing frame task. In either
case, the real value returned is an indication of how many seconds it will
be before the message can begin being processed (i.e., how long until the
end of the current processing frame based on the current loop time). The
TRANSACTION ID returned with this message will match the ID from
the command request which is being deferred. When the message actually
gets processed, the “real” response will also have the TRANSACTION ID
of the original request.

| | |
|---|---|
| Boomerang | CMD_SUB_CODE == [FE] |
| | PARAM == 0 |
| | SEC_PARAM == 0 |
| | Contents |
| | { |
| | uint8 data |
| | } |
| | Response |
| | { |
| | uint8 data |
| | } |

This command takes whatever is in the data portion of the message and
drops it into the outgoing queue as an “echo”.

Record Object: HEADER

The HEADER data object defines the beginning of a block data transfer from the fieldbus device 15 to a host application or from a host application to the fieldbus device 15. This record is the “memory template overlay” for the XA_HEADER parameter in the transducer blocks 17a-17e. The 110-byte array returned from the device 15 should be interpreted according to Table VI. Descriptions of the individual fields in the HEADER object appear in Table VII.

TABLE VI

| | | Data Type | Size | | | |
|---|---|---|---|---|---|---|
| Parameter Name | Access | (Index) | (bytes) | Range | Range Check | Default Value |
| ACTION | RW | TOKEN | 8 | | | |
| TIMESTAMP | RW | OSTR (10) × 8 | 8 | SDD-524 | 20030117184500e | all zero |
| TOTAL_LENGTH | RW | U32 (7) | 4 | [25,] | | 25 |
| OVERALL_CRC | RW | U16 (6) | 2 | | | 0 |
| NEW_STREAM_ID | RW | U8 (5) | 1 | [1, 126] | | zero |
| DATABLOCK | RW | U8 (5) × 85 | 85 | | | all zero |
| HEADER_CRC | RW | U16 (6) | 2 | | | 0 |

TABLE VII

| Parameter | Description |
|---|---|
| ACTION | This field identifies the logical contents of the block data transfer being started. In the case of an |
| | uplink request it will be an echo of the command as written by the host application. |
| TIMESTAMP | This field is a packed ISO time value indicating the time at which this header was submitted for |
| | transmittal. For unsolicited data, this will be the time when the event occurred which caused the |
| | data to be queued. For upload requests, this will be the time when the request was recognized |
| | and the response queued. |
| TOTAL_LENGTH | This field is a numeric quantity specifying the total number of bytes to be transferred, including |
| | the header and all segments. The smallest transfer is a header for a total of twenty-five (25) |
| | bytes. Therefore, this field is defined on the closed interval [25,U32_MAX (2³²−1)]. |
| OVERALL_CRC | This field is the CCITT-16 cyclic redundancy check value over the data (octets) for the entire |
| | stream. |
| NEW_STREAM_ID | This field specifies the stream identifying token which will be sent in all segments associated |
| | with this specific block transmission. It is defined on the closed interval [1,126]; zero and 127 |
| | are reserved values. |
| DATABLOCK | This octet array contains the initial subset of bytes out of the total block transmission as |
| | identified by the stream identifier, segment identifier, and the following sequence identifier. The |
| | number of valid bytes from the beginning of the array is defined on the closed interval [1,85]. |
| HEADER_CRC | This field is the CCITT-16 CRC check value over the HEADER block to ensure its validity. |

Record Object: SEGMENT

The SEGMENT data object encapsulates the concept of a single segment within a multi-segment data transfer from the fieldbus device 15 to a host application or from a host application to the fieldbus device 15. This record is the “memory template overlay” for the XA_SEGMENT parameter in the transducer blocks 17a-17e. The 110-byte array returned from the device 15 should be interpreted according to Table VIII. Descriptions of the individual fields in the SEGMENT object appear in Table IX.

TABLE VIII

| | Class | Use | | | Data Type | Size | | Range | |
|---|---|---|---|---|---|---|---|---|---|
| Parameter Name | (D/S/N) | (I/O/C) | Access | Mode | (Index) | (bytes) | Range | Check | Default Value |
| SEQUENCE_ID | SD | C | RW | Any | U32 (7) | 4 | | | 0FFFFFFFF₁₆ |
| DATABLOCK | SD | C | RW | Any | U8 (5) × 104 | 104 | | | all zero |
| SEGMENT_CRC | SD | C | RW | Any | U32 (7) | 2 | | | 0FFFFFFFF₁₆ |

TABLE IX

| Parameter | Description |
|---|---|
| SEQUENCE_ID | This 32-bit (4 octet) field contains the unique sequence identifier for this particular segment out of |
| | the whole block transmission identified by the stream identifier. It is composed of two (2) sub- |
| | fields as follows: |
| | STREAM_ID |
| | This sub-field (1 octet) located in the LSB position contains the stream identifying token |
| | associated with this specific block transmission in the initiating HEADER. Its format definition |
| | is provided in the description of NEW_STREAM_ID for the HEADER record. |
| | SEGMENT_ID |
| | This sub-field (3 octets) located in the three (3) MSB positions contains the unique identifier for |
| | this segment out of all possible segments for this specific block transfer. |
| | It is defined on the closed interval [1,2²⁴−1] with zero being a reserved value. This permits a |
| | maximum transfer length of 1879048173 bytes (≈1790 MB-sufficiently large to satisfy any |
| | foreseeable requirements ...) |
| | The number of segments is calculated as |
| | (TOTAL_LENGTH − HEADERPAYLOAD + (SEGMENTPAYLOAD − 1))/SEGMENTPAYLOAD. |
| | Any particular segment id is calculated as |
| | (CURRENTPOSITION − HEADERPAYLOAD) / SEGMENTPAYLOAD + 1. |
| | The overall structure of this field is therefore |
| | ((SEGMENT_ID & 0xFFFFFF) << 24) \| (STREAM_ID & 0xFF). |
| DATABLOCK | This octet array contains the set of bytes out of the total block transmission as uniquely identified |
| | by the stream identifier, segment identifier, and the following sequence identifier. |
| | The number of valid bytes, counting from the beginning of the array, is defined on the closed |
| | interval [1,104]. The actual number of valid bytes will be MIN(104,REMAINING_LENGTH) |
| | where the REMAINING_LENGTH is calculated by subtracting the total number of overhead and |
| | payload octets transferred so far from the original TOTAL_LENGTH value in the stream header. |
| SEGMENT_CRC | The CCITT16 cyclic redundancy check over the contents of this segment, including the |
| | SEQUENCE_ID field. The initial seed used should be ˜0. |

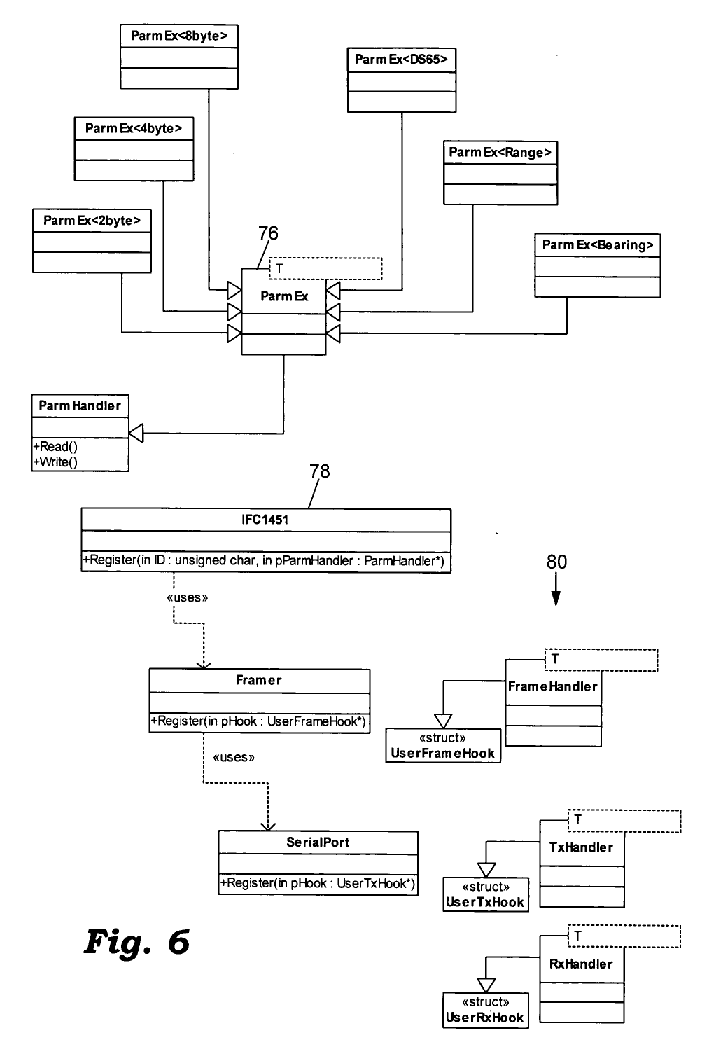

FIG. 6 shows the lowest level of the “network” stack for communications between the fieldbus output board 16 and the field device 12. This is referred to as the Rosemount FOUNDATION™ Fieldbus Interface (RFFI). The IFC1451 class 78 contains lists of handlers 80 (callback routines) associated with the parameter identifiers for each block. These routines deal with the FMS read and write operations to decouple the communication interface from the actual data representations.

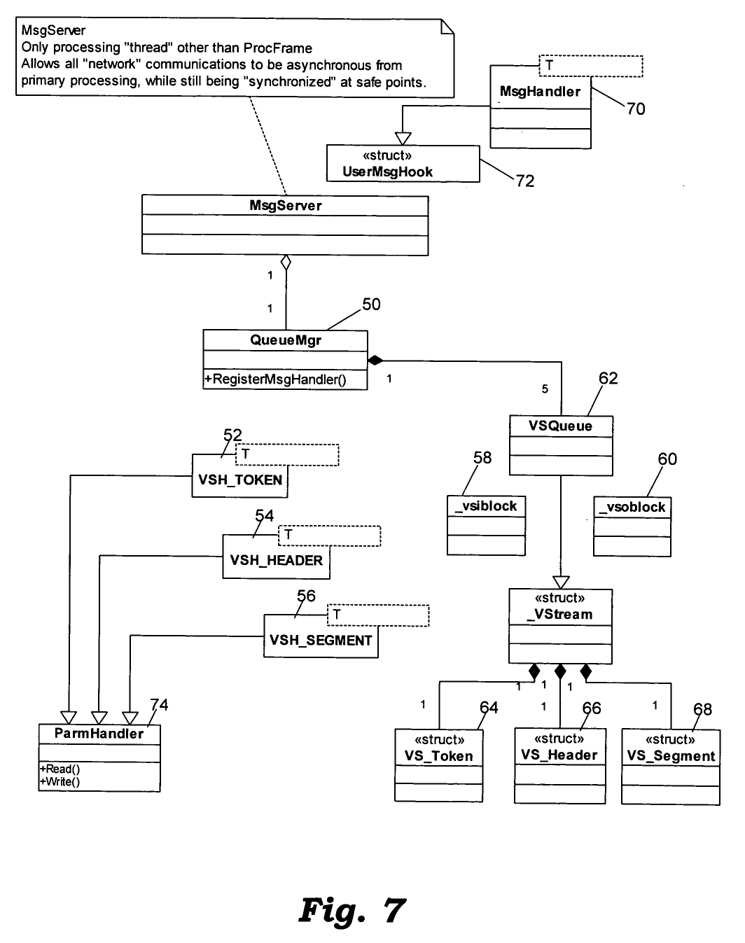

FIG. 7 shows the logical messaging infrastructure layered on top of the RFFI to manage VStreams™. The queue manager 50 is responsible for managing the streams on all queues associated with the transducer blocks. It also maintains the message handler dispatch lists for each queue. The application firmware subscribes for various messages by associating a callback routine with the COMMAND token value it is supposed to handle.

Basic descriptions of the primary classes depicted in FIGS. 6 and 7 are set forth in Table X. It will be obvious to one reasonably skilled in the art that these descriptions are provided as examples of one possible implementation. Many other specific implementations can be envisioned without departing from the teachings presented here.

TABLE X

| Class | Description |
|---|---|
| in_buf & | This pair of classes provides the underlying capability to serialize messages into and out of a |
| inout_buf | buffer. It has an extremely simplified interface and it is very easy to add new insert and extract |
| | operators for new data types as necessary. One very important attribute is the ability to attach an |
| | in_buf to an existing block of memory for input serialization. |
| VSH_TOKEN | This is a specialization of ParmEx< > (76) for a VS_Token. An instance of this class gets |
| (52) | registered to handle each TOKEN parameter in the transducer blocks. |
| VSH_HEADER | This is a specialization of ParmEx< > (76) for a VS_Header. An instance of this class gets |
| (54) | registered to handle each HEADER parameter in the transducer blocks. |
| VSH_SEGMENT | This is a specialization of ParmEx< > (76) for a VS_Segment. An instance of this class gets |
| (56) | registered to handle each SEGMENT parameter in the transducer blocks. |
| _vsiblock (58) | This class contains bookkeeping information for managing an active input VStream (download). |
| | An instance of this class gets created whenever a HEADER is written to initiate a download and |
| | remains in existence until the contents of the VStream transaction get passed off to the message |
| | dispatcher. |
| _vsoblock (60) | This class contains bookkeeping information for managing an active output VStream (upload/ |
| | response). An instance of this class gets created whenever an output is initiated from within the |
| | device and remains in existence until the contents of the VStream have been successfully |
| | transferred to the host. |
| VSQueue (62) | This class represents the concept of uploads and downloads through a VStream. It contains the |
| | TOKEN queue (64), download HEADER (66), active download list for reassembling the stream |
| | from SEGMENT fragments (68), the upload HEADER list for pending outputs, and the active |
| | upload list for sequencing SEGMENT fragments. |
| VSQueueEx | This specialization of VSQueue (62) adds the concept of a map of message handlers. Message |
| | handlers are dispatched on the basis of TOKEN contents. |
| CQueMgr (50) | This class encapsulates the entire concept of a message management facility. It contains the code |
| | to manage all VStreams and dispatch the message handlers for collected commands and |
| | messages on demand. |
| MsgHandler< > | This template class allows a particular TOKEN value to be associated with an arbitrary method |
| (70) | on an arbitrary class instance (the method signature must match the UserMsgHook prototype |
| | (72)). |

Data Compression on Fieldbus

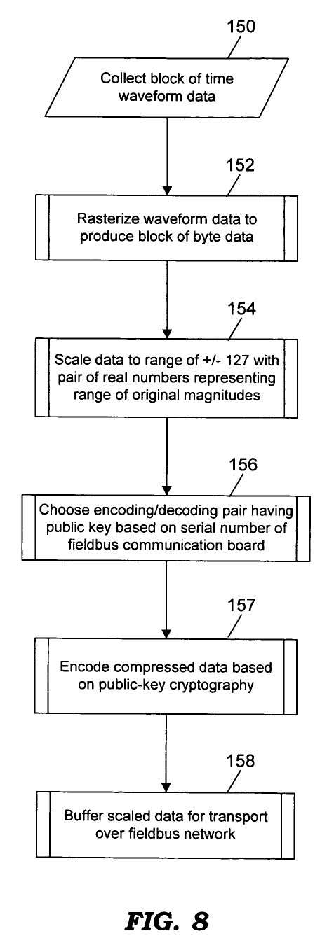

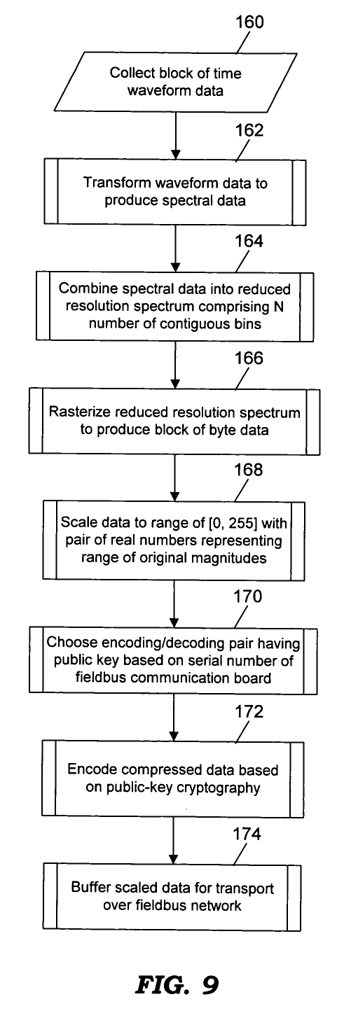

A preferred embodiment of the invention also provides for improving throughput of arbitrary data transfers over an active fieldbus network. Because typical fieldbus networks are fairly slow and generally support moving data only in small quantities, it becomes very important to maximize the utilization of the available bandwidth. Given that the VStream™ technique described above provides for movement of arbitrary blocks of data across such a network, it is desirable to compress the data being transferred. Accordingly, the invention provides a data compression technique that is directly related to the domain data being transferred, specifically waveform and spectral blocks. Preferred embodiments of the compression technique are depicted in FIGS. 8 and 9. Although the technique is described in the context of time waveform and frequency spectrum data, it will be appreciated this technique is generally applicable to any similar type of data which can be represented as real arrays.

According to a preferred embodiment of the invention depicted in FIG. 8, a block of real waveform data is “rasterized” using a graphic pipeline technique (step 152) to produce a resulting block of byte data scaled to the range of ±127 (minimum magnitude=−127, maximum magnitude−+127) and a pair of real numbers representing the range of the original magnitudes (step 154). This is an effective compression ratio of 4:1.

As shown in FIG. 9, prior to rasterization, a block of real spectral data may be reduced by combining the energy in sets of contiguous bins to produce a reduced resolution spectrum (step 164). This is an effective compression ratio of N:1 where N is the number of contiguous bins combined. The resulting spectrum is then “rasterized” (step 166) to produce a block of byte data scaled to the range of [0,255] and a pair of real numbers which represent the range of the original magnitudes (step 168). This is a further compression of 4:1. In a typical application where the original spectrum is 6400 lines and the combined spectrum is 100 lines, the overall compression ratio is (4*[6400/100])=256:1.

Blocks of real-valued historical trend data may be processed in a fashion identical to the waveform. Sets of statistical blocks of data may be concatenated and treated as a waveform. Combining large magnitude and small magnitude data in the same block should be avoided to prevent unacceptable loss of resolution due to quantization artifacts. As would be apparent to one skilled in the art, before any particular stream of bytes is presented to the block transporter for fragmentation, any standard compression algorithm, such as Adaptive Huffman Encoding or one of the Lempel-Ziv variants may be applied.

This technique does not depend on the arbitrary block transport mechanism used, nor does any particular implementation of a block transport mechanism depend on the availability of this technique.

Data Encryption on Fieldbus

A preferred embodiment of the invention provides a technique for safeguarding the proprietary contents of arbitrary application domain data being transferred across an active fieldbus network. Typical fieldbus networks generally move simple scalar process values and alarm notifications. Few, if any, of these values could be considered “sensitive” in themselves, although the integrity of the process as a whole probably would be. Given that the VStream™ technique described above provides for movement of arbitrary blocks of data across a fieldbus network, it is desirable to take some steps to protect any proprietary data being transferred.

It is possible for a compression algorithm to function as an “encoder,” in that the normal form of the data is altered. Thus, a first level protection mechanism is to implement a compression technique, such as that described above. It is further desirable, however, to implement a more sophisticated technique to protect large blocks of sensitive information, particularly when the transport and compression techniques are public knowledge.

In the preferred embodiment of the invention, the higher level of protection is attained by encoding the compressed data stream using a variant of public-key cryptography. (Step 157 in FIG. 8 and step 172 in FIG. 9.) The encoding/decoding pair is chosen such that the public key is the Machine Address Code (MAC) of the fieldbus communications board, because it is readily available to a communicating entity, is unique per device, and is sufficiently “small” to be exportable. (Step 156 in FIG. 8 and step 170 in FIG. 9.) Other values that meet these criteria would also be suitable.

Alternatively, the encryption keys are assigned as part of the manufacturing process and are retained in non-volatile storage, as are other configuration data. This technique will work on the uncompressed stream as well. However, if compression is going to be used, it is best to do the compression first to take advantage of redundancy in the original (application domain) data. The output of a reasonably secure cryptographic technique is typically not as amenable to compression.

This encryption technique does not depend on the arbitrary block transport and/or compression mechanisms used, nor does any particular implementation of a block transport or compression mechanism depend on the availability of this technique.

“Hot” Firmware and Configuration Module Updates on Fieldbus

A preferred embodiment of the invention also provides a mechanism for updating firmware in an active device on an active fieldbus network without ceasing normal operation. Typical fieldbus devices must be taken out of service to update their firmware. Frequently they must also be isolated from the fieldbus network and require a separate connection mechanism for downloading and updating the operational firmware. Given that the VStream™ technique described above provides for movement of arbitrary blocks of data across such a network, it is desirable to download firmware updates to a fieldbus device utilizing standard capabilities of the active fieldbus network.

In the preferred embodiment of the invention, the fieldbus device 15 has sufficient storage space to buffer the entire upgrade to minimize the amount of time the device is unavailable, and is capable of remembering its configuration and status in order to resume operation smoothly after the upgrade.

The invention takes advantage of modularity in the operational firmware to allow upgrading subsets of the overall operating code base independently. According to the invention, an appropriate module is transferred to the device from an application at the host using the generic transport mechanism. The device accumulates the module upgrade and replaces it in the program flash module while continuing to perform normal operation. These steps are repeated until all desired modules have been updated in the device. At a convenient or appropriate time the device is commanded to save its current operating state and restart operations using the new firmware module(s). The same mechanism may be used in reverse to upload one or more firmware modules for archival or recovery purposes.

The foregoing descriptions of preferred embodiments for this invention have been presented for purposes of illustration and description. They are not intended to be exhaustive or to limit the invention to the precise form disclosed. Modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

What is claimed is:

1. A method for transferring data in one or more data streams in a fieldbus network, the method comprising:
(a) defining a fieldbus-supported parameter for use as a window;
(b) reading through the parameter a header block containing identification information for uniquely identifying one of the data streams comprising N number of segments of data;
(c) reading through the parameter a data block containing one of the N number of segments of the data in the data stream identified by the identification information in the header block;
(d) repeating step (c) until all of the N number of segments of data have been read through the parameter;
(e) reassembling the N number of segments in the one or more data streams.

2. The method of claim 1 wherein writes to the parameter are interpreted as sequential transfers of data into a field device on the fieldbus network, and reads from the parameter are interpreted as sequential transfers of data out of the field device.

3. The method of claim 1 wherein step (b) further comprises reading the header block containing information indicating the value of N.

4. The method of claim 1 wherein step (c) further comprises reading the data block containing a stream identifier for identifying the data block as containing a data segment from the data stream identified by the identification information in the header block.

5. The method of claim 1 wherein step (c) further comprises reading the data block containing a segment identifier for uniquely identifying which of the N number of data segments is contained in the data block.

6. A method for transferring data over a fieldbus network, the method comprising:
(a) dividing the data into data segments;
(b) transporting the data segments over the fieldbus network; and
(c) reassembling the data segments.

7. The method of claim 6 wherein step (a) further comprises dividing the data into the data segments at a field device on the fieldbus network and step (c) further comprises reassembling the data segments at a host device on the fieldbus network.

8. The method of claim 6 wherein step (a) further comprises dividing the data into the data segments at a host device on the fieldbus network and step (c) further comprises reassembling the data segments at a field device on the fieldbus network.

9. The method of claim 8 further comprising updating firmware in the field device based on the reassembled data segments while maintaining normal operation of the field device.

10. The method of claim 6 wherein step (a) further comprises dividing the data into arbitrarily sized data segments.

11. The method of claim 6 wherein step (a) further comprises:
(a1) defining a fieldbus-supported parameter for use as a window;
(a2) reading through the parameter a header block containing identification information for uniquely identifying a data stream comprising N number of segments of data;
(a3) reading through the parameter a data block containing one of the N number of segments of the data in the data stream identified by the identification information in the header block; and
(a4) repeating step (a3) until all of the N number of segments of data have been read through the parameter.

12. The method of claim 6 wherein step (a) further comprises buffering the data segments in a field device on the fieldbus network, and step (b) is initiated based at least in part upon a polling operation from a host device on the fieldbus network.

13. The method of claim 12 further comprising the host device detecting when an exceptional condition has occurred in a machine monitored by the field device, wherein the polling operation is initiated by the host device based on detection of the exceptional condition.

14. The method of claim 12 wherein the polling operation is initiated periodically by the host device based on a timing operation of the host device.

15. The method of claim 6 further comprising rasterizing the data to produce the segments of data scaled to a range of n₁ to n₂, where a pair of numbers m₁ and m₂ represent original minimum and maximum magnitudes of the data in the segments.

16. The method of claim 15 wherein n₁ to n2 represents a range of ₂₅₆ integer values.

17. A method for transferring data in one or more data streams over a fieldbus network using a Fieldbus Messaging Specification including a TRANSFER parameter and a SLIDING_WINDOW parameter, the method comprising:
(a) reading through the TRANSFER parameter a first header block containing first identification information for uniquely identifying a first data stream comprising N number of segments of data;
(b) reading through the SLIDING_WINDOW parameter a data block containing one of the N number of segments of the data in the first data stream; and
(c) repeating step (b) until all of the N number of segments of data in the first data stream have been read through the SLIDING_WINDOW parameter.

18. The method of claim 17 further comprising:
(d) writing through the TRANSFER parameter a second header block containing second identification information for uniquely identifying a second data stream comprising M number of segments of data;
(e) writing through the SLIDING_WINDOW parameter a data block containing one of the M number of segments of the data in the second data stream; and
(f) repeating step (e) until all of the M number of segments of data in the second data stream have been written through the SLIDING_WINDOW parameter.
